(19) United States
(12) Patent Application Publication
(10) Pub. No.: US 2003/0055697 A1
(43) Pub. Date: Mar. 20, 2003

(54) Systems and methods to facilitate migration of a process via a process migration template

(76) Inventors: Thomas E. Macken JR., Riverside, CT (US); Lesly Regis, Trumball, CT (US)

Correspondence Address: Buckley, Maschoff, Talwalkar & Allison LLC, 5 Elm Street, New Canaan, CT, 06840, US

(21) Appl. No.: 09/997,406

(22) Filed: Nov. 29, 2001

Related U.S. Application Data
(60) Provisional application No. 60/323,066, filed on Sep. 18, 2001.

(51) Int. Cl. G06F 17/60

(52) U.S. Cl. 705/7

(57) ABSTRACT

Systems and methods are provided to facilitate process migration. According to one embodiment, information associated with a process performed at a first location is received via a process migration template. For example, a migration controller may receive information associated with a business process from a user device or a customer device. At least one adaptation to the process is determined to facilitate performance of the adapted process at a second location, and it is arranged for the adapted process to be performed at the second location.

### CROSS-REFERENCE TO RELATED APPLICATIONS

This application claims the benefit of U.S. Provisional Patent Application No. 60/323,066 entitled “Work Transition Template” and filed Sep. 18, 2001. The entire contents of that application are incorporated herein by reference.

### FIELD

The present invention relates to processes, such as business processes. In particular, the present invention relates to systems and methods to facilitate migration of a process via a process migration template.

### BACKGROUND

A company that performs a process at a one location might be able to more effectively or efficiently perform that process at another location. Consider, for example, a company that performs a client invoicing process at an office in New Jersey. In this case, the company might be able to perform that process at a lower cost in Florida—or even in another country.

It can be difficult, however, for a company to identify processes that are appropriate candidates for migration to another location. For example, the migration of a process might be impractical due to the nature of the process (e.g., a process might be too complex and/or interconnected to other processes to be moved) or because of legal issues associated with the process. Similarly, it may not be financially feasible to perform a process migration (e.g., substantial migration costs could outweigh a minimal savings per transaction associated with the new location). In addition, it could be unwise to migrate a process from a human resources perspective (e.g., there may be little chance of hiring employees with the necessary skills at the other location). Traditionally, the identification of a process for such a transition is performed by a manager or a consultant in an ad hoc manner. That is, processes are generally identified case-by-case based on subjective information. This type of approach may fail to identify an appropriate process or even incorrectly identify a process that is not appropriate for migration.

This may be especially true when a company is performing or reviewing a significant number of tasks.

Moreover, even when an appropriate candidate for migration has been identified, the migration itself may can cause a number of problems. For example, the process may be moved before the other location is fully ready to perform the process (e.g., because one or more performance requirements were not recognized). Similarly, a company may find that the quality of the process has suffered because of the migration (e.g., more mistakes may be made at the new location).

### SUMMARY

To alleviate problems inherent in the prior art, the present invention introduces systems and methods to facilitate migration of a process via a process migration template.

According to one embodiment, information associated with a process performed at a first location is received via a process migration template. At least one adaptation to the process is determined to facilitate performance of the adapted process at a second location, and it is arranged for the adapted process to be performed at the second location.

Another embodiment is directed to a computer-implemented method of facilitating process migration. According to this embodiment, information associated with a business process performed at a first geographic location is received via a process migration template. It is determined that an adapted business process will be performed at a second geographic location, and documents associated with the adapted business process are automatically generated. The adapted business process is then performed at the second geographic location.

One embodiment of the present invention comprises: means for receiving, via a process migration template, information associated with a process performed at a first location; means for determining at least one adaptation to the process to facilitate performance of the adapted process at a second location; and means for arranging for the adapted process to be performed at the second location.

Another embodiment comprises: means for receiving via a process migration template information associated with a business process performed at a first geographic location; means for determining that an adapted business process will be performed at a second geographic location; means for automatically generating documents associated with the adapted business process; and means for performing the adapted business process at the second geographic location.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of a process migration system according to some embodiments of the present invention.

FIG. 2 is a flow chart of a process migration method according to some embodiments of the present invention.

FIG. 3 illustrates process migration steps according to some embodiments of the present invention.

FIG. 4 is a process migration scorecard display according to some embodiments of the present invention.

FIG. 5 illustrates activities performed during a process migration according to some embodiments of the present invention.

FIG. 6 is a process migration tollgate display according to some embodiments of the present invention.

FIG. 7 is a process migration readiness display according to some embodiments of the present invention.

FIG. 8 is a process migration issues display according to some embodiments of the present invention.

FIG. 9 is a block diagram of a migration controller according to an embodiment of the present invention.

FIG. 10 is a tabular representation of a portion of a process migration database according to an embodiment of the present invention.

FIG. 11 is a flow chart of a process migration method according to some embodiments of the present invention.

### DETAILED DESCRIPTION

Embodiments of the present invention are directed to systems and methods to facilitate migration of a “process.” As used herein, the term “process” may refer to any procedure that may be performed. Examples of processes include business processes, accounting processes (e.g., an accounts receivable processes), telephone call center processes (e.g., a help center process) and human resources processes (e.g., a payroll process).

Process Migration System Overview

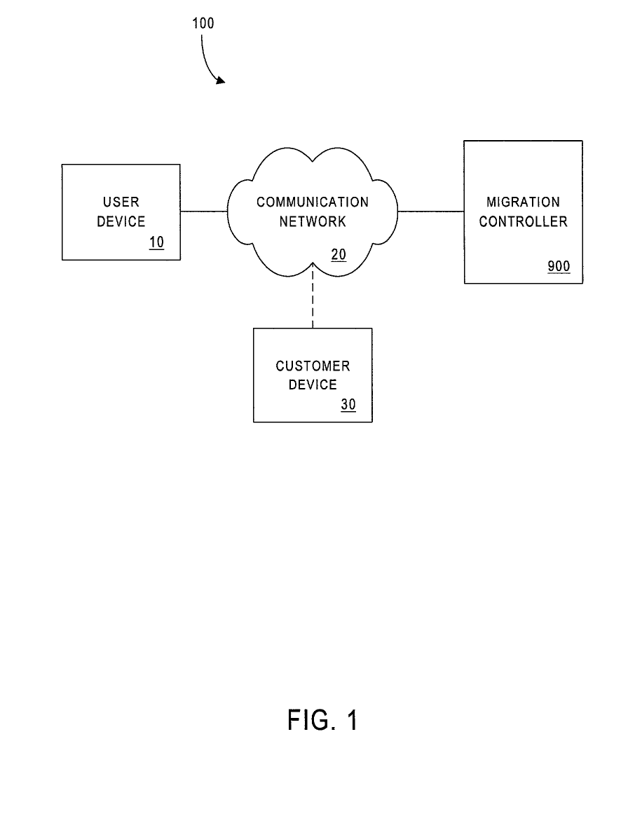

Turning now in detail to the drawings, FIG. 1 is a block diagram of a process migration system 100 according to some embodiments of the present invention. The process migration system 100 includes a migration controller 900 in communication with a user device 10 through a communication network 20. The communication network 20 may comprise, for example, a Local Area Network (LAN), a Metropolitan Area Network (MAN), a Wide Area Network (WAN), a proprietary network, a Public Switched Telephone Network (PSTN), a Wireless Application Protocol (WAP) network, or an Internet Protocol (IP) network such as the Internet, an intranet or an extranet.

The migration controller 900 and the user device 10 may be any devices capable of performing the various functions described herein. The migration controller 900 may be, for example, a server associated with a Web site. The user device 10 may be, for example, a Personal Computer (PC) adapted to run a Web browser application (e.g., MICROSOFT® INTERNET EXPLORER®) or a portable computing device such as a laptop computer or a Personal Digital Assistant (PDA).

Note that the devices shown in FIG. 1 need not be in constant communication. For example, the migration controller 900 may communicate with the user device 10 on an as-needed or periodic basis. Moreover, although a single migration controller 900 and user device 10 are shown in FIG. 1, any number of these devices may be included in the process migration system 100. For example, multiple user devices 10 (in one or more locations) may exchange information with the migration controller 900. Similarly, a single device may act as both a user device 10 and a migration controller 900.

According to one embodiment, the migration controller 900 also exchanges information with a customer device 30. The customer device 30 may be associated with, for example, a business or an employee involved with a process.

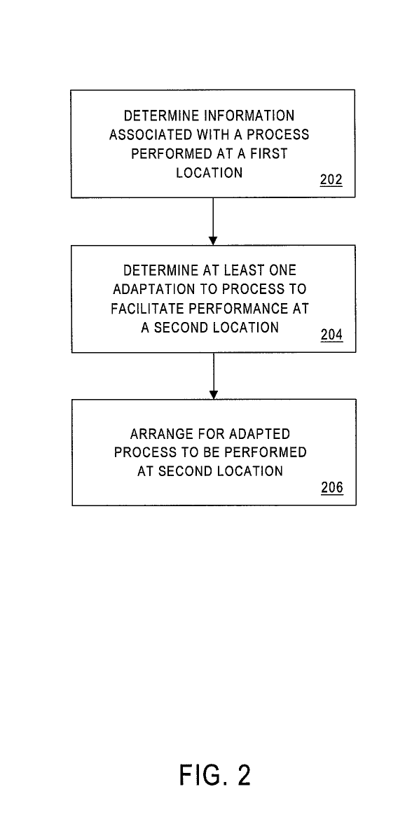

According an embodiment of the present invention, the migration controller 900 facilitates process migration. In particular, FIG. 2 is a flow chart of a process migration method according to some embodiments of the present invention. The flow charts in FIG. 2 and the other figures described herein do not imply a fixed order to the steps, and embodiments of the present invention can be practiced in any order that is practicable.

At 202, information associated with a process performed at a first location is determined. For example, the migration controller 900 may receive information from one or more user devices 20 via a process migration template. As used herein, a “process migration template” may comprise, for example, a text, graphical, or any other structure that facilitates the exchange of information associated with process migration. Note that templates may be associated with, for example, MICROSOFT® WORD, EXCEL, POWERPOINT, INTERNET EXPLORER, PROJECT or any other software program. Moreover, the term “location” may refer to, for example, a company, a department, a region and/or a country. That is, a process may be moved, for example, from a first company to a second company or from a first country to a second country.

At 204, at least one adaptation to the process is determined to facilitate performance of the adapted process at a second location. For example, a user or the migration controller 900 may review the information received at 202 to determine an appropriate adaptation to the process.

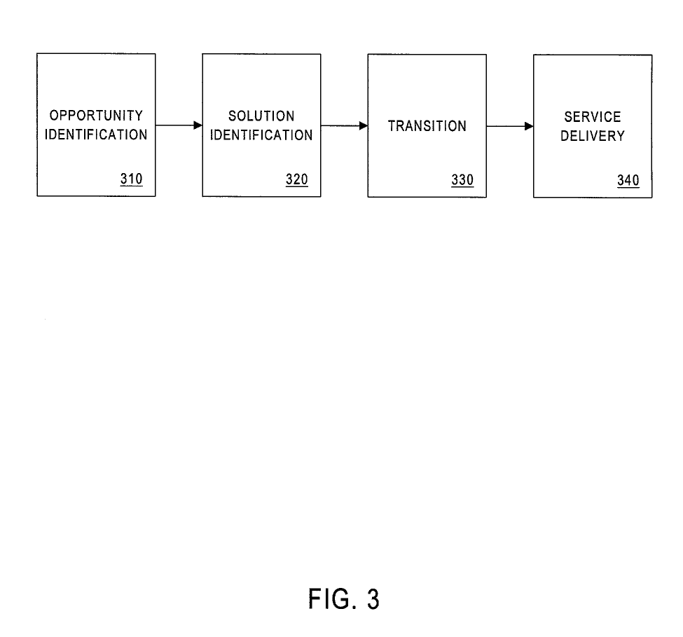

At 206, it is arranged for the adapted process to be performed at the second location. For example, the migration controller 900 may automatically generate documents (i.e., at least part of the documents may be automatically generated) and/or create other information to facilitate the transition of the process from the first location to the second location. A more detailed description of process migration according to some embodiments of the present invention is provided with respect to FIGS. 3 through 8.

Process Migration

FIG. 3 illustrates process migration steps according to some embodiments of the present invention. At 310, a process migration opportunity is identified. Consider a customer that currently performs various business processes, such as accounting functions and telephone call center operations, at a first location. After an initial review of the business, the customer may be presented with high-level outsourcing ideas and savings potentials (e.g., without linking this information to a particular process).

At 320, one or more particular solutions are identified. That is, one or more business processes are identified as candidates for migration to a second location (e.g., from the United States to India). To help identify these solutions, an opportunity identification team might interface with the customer to evaluate processes and to define the customer's expectations. As another example, a finance group might provide cost information useful to identify potential solutions. Similarly, capability and resource information might be collected in connection with the first location and/or the second location.

The customer's needs and processes are then be investigated in more detail. For example, a process migration “toolkit” (i.e., a set of tools adapted to facilitate process migration) may include a template associated with an initial questionnaire to be completed by the customer (e.g., a MICROSOFT® WORD template). Such a questionnaire might be used, for example, to understand a process and to estimate an amount of time that may be required at the first location to further investigate the process and/or to perform a migration. According to one embodiment, the questionnaire is automatically generated and/or transmitted to one or more customer employees (e.g., one section of the questionnaire may be transmitted to a human resources manager while another section is transmitted to a legal department). By way of example, the initial questionnaire could include some or all of the following sections: a contact list, a process description (e.g., including operations, measurements, control aspects and evolution), information technology aspects, human resources aspects, financial aspects, quality information, legal issues and customer expectations.

After the customer's needs and the processes are fully understood, potential solutions are conceptualized. For example, the process migration toolkit may include a process migration scorecard template (e.g., a MICROSOFT® EXCEL template) to help identify and/or prioritize a potential business activity for migration. Such a scorecard template may be especially useful when there are multiple customer processes, some of which may not be suitable for migration.

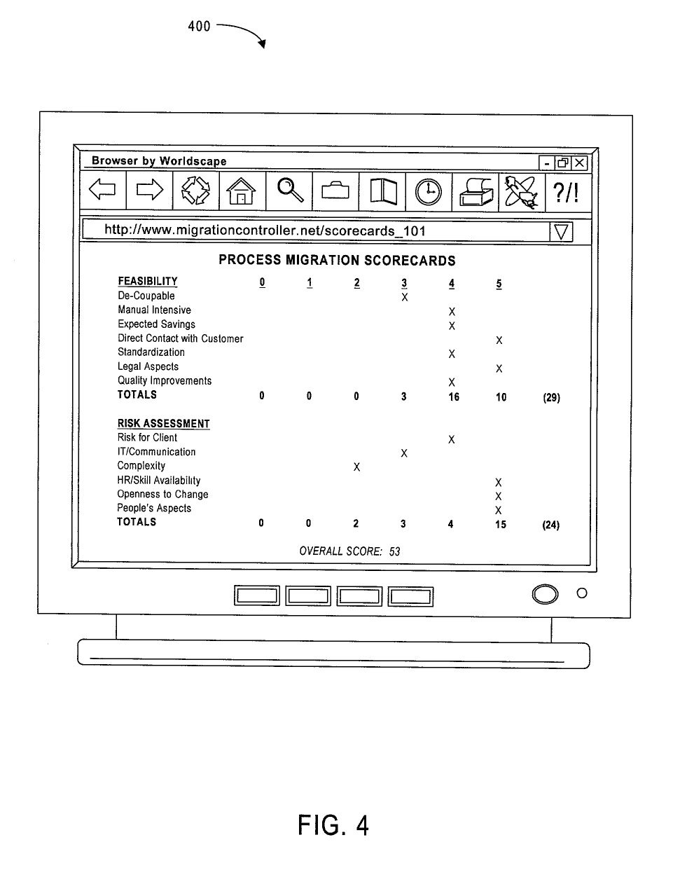

FIG. 4 is a process migration scorecard display 400 according to some embodiments of the present invention. As can be seen, the display 400 includes a feasibility scorecard and a risk assessment scorecard. Each scorecard includes a number of factors that are rated from “0” (difficult migration) to “5” (easy migration). For example, the complexity of the process is rated “2” indicating that some knowledge and/or ability will be required to perform the process. An overall score is then computed based on these ratings, and the overall score is used to determine whether the process should be migrated. According to one embodiment, certain ratings result in pre-determined actions. For example, a rating below “3” may trigger generation of a risk mitigation action plan.

The process migration toolkit can also include more detailed questionnaire templates, such as a technology questionnaire template associated with hardware requirements. For example, the technology questionnaire may be used to determine network configurations, storage capacity, back-up frequencies and/or server types (e.g., UNIX® or NT®). Similarly, the process migration toolkit can include a telecommunication questionnaire template (e.g., associated with a telephone call center business process).

Information associated with Full Time Employee (FTE) values (e.g., fifty employees from January through September and sixty employees from October through December) and ramp-up plans for the second location may also be determined via a process migration toolkit template. Prior customer staffing plans (i.e., historical information) can also be used to determine appropriate FTE values. According to one embodiment, information in a FTE plan is automatically used to generate requisitions, such as human resources, technology and/or telecommunication requisitions. For example, a human resources requisition form may be generated and used to initiate hiring of new employees needed for the process. The human resources requisition may also indicate the appropriate skills that are required for those employees (e.g., UNIX® and database administrator skills).

One or more potential solutions are then presented to the customer. For example, the process migration toolkit may include a solution identification report template, including the following sections: executive summary, process understanding, adapted process, transition plan, financials (e.g., savings to the customer if the process is migrated to the second location), risks and mitigants and/or next steps. This may provide the customer with a basis to decide whether the process should be migrated at all.

The process migration toolkit may also automatically generate a letter of commitment (e.g., quoting a price per transaction if the process is moved to the second location) to be signed by the customer if it is determined that the process migration will be performed.

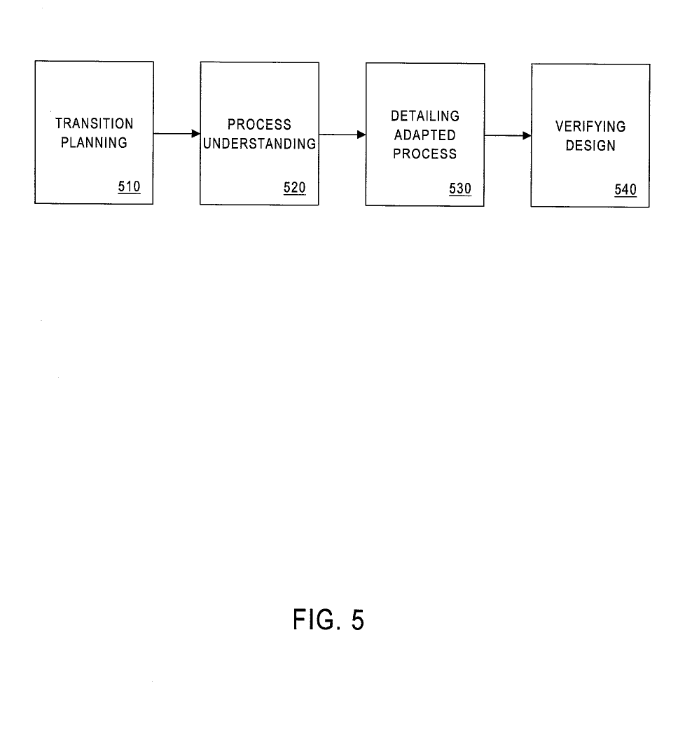

Referring again to FIG. 3, the transition of the process from the first location to the second location is performed at 330. In particular, FIG. 5 illustrates in detail some activities associated with such a transition.

At 510, transition planning is performed. That is, once the customer agrees to migrate the process from the first location to the second location, a detailed plan for the migration is developed. According to some embodiments, the plan includes one or more “tollgates” or points at which migration information will be reviewed by relevant parties (e.g., the customer and key employees at the second location). Such tollgates may smooth the transition (e.g., by identifying problems early in the transition) and help ensure that the migration meets the customer's expectations. By way of example, a process migration toolkit template might automatically establish tollgates between each of the steps illustrated in FIG. 5.

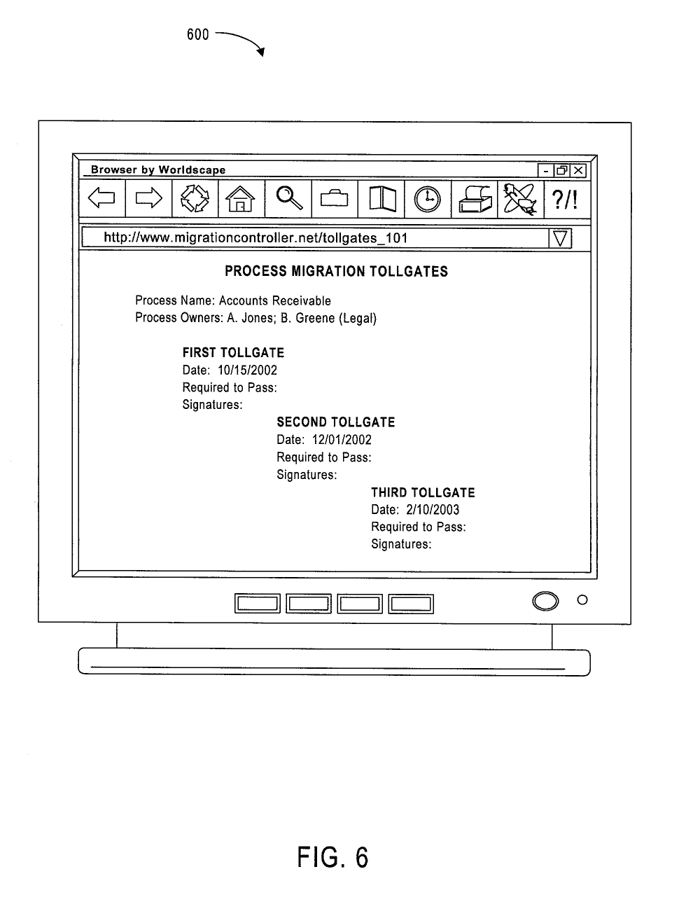

FIG. 6 is a process migration tollgate display 600 according to some embodiments of the present invention. As can be seen, each tollgate may be associated with a date, one or more requirements that must be met to successfully pass the tollgate (e.g., no major issues are outstanding) and an approval procedure (e.g., signatures). Tollgates may also be associated with, for example, key process owners (e.g., legal, compliance, quality, human resources and/or finance process owners).

An overall transition plan and schedule may also be automatically generated to migrate the process (e.g., via a process migration toolkit MICROSOFT® PROJECT template). The transition plan may include, for example, a number of tasks (e.g., create work spaces, install equipment and hire employees) and associated dates.

A training plan may also be automatically developed, such as a plan generated via a process migration toolkit MICROSOFT® EXCEL template. Such a training plan may, for example, establish dates, methodologies and deliverables associated with training. A training record may also be generated to document training that has been provided to employees at the second location.

Similarly, a communication plan may be automatically generated, such as a plan generated via a process migration toolkit MICROSOFT® WORD template. The communication plan may, for example, formalize expected deliverables by establishing a purpose (e.g., update project manager), a content (e.g., transaction targets), a medium (e.g., electronic mail message or telephone call), a frequency (e.g., daily or monthly), an author, a date and/or a distribution list for each communication.

Referring again to FIG. 5, a detailed understanding of the process is obtained at 520. According to some embodiments, the process to be migrated is initially documented via a high level process map. That is, activities associated with the process are described in a logical order and suppliers, inputs, outputs and/or customers associated with the process are identified. Based on the high level process map, a more detailed mapping is performed to obtain quality and comprehensive information about the process as it is currently performed at the first location.

The detailed mapping may include baseline parameters associated with the process. For example, minimum and maximum telephone call volume values may be established for a telephone call center. Other examples of baseline parameters include an FTE value, an average response time and a per-transaction cost. The parameters can then be used to assess, for example, the performance of the process and/or employees at the second location (e.g., via a performance tracking template). According to some embodiments, post-migration target parameters are also established for the process.

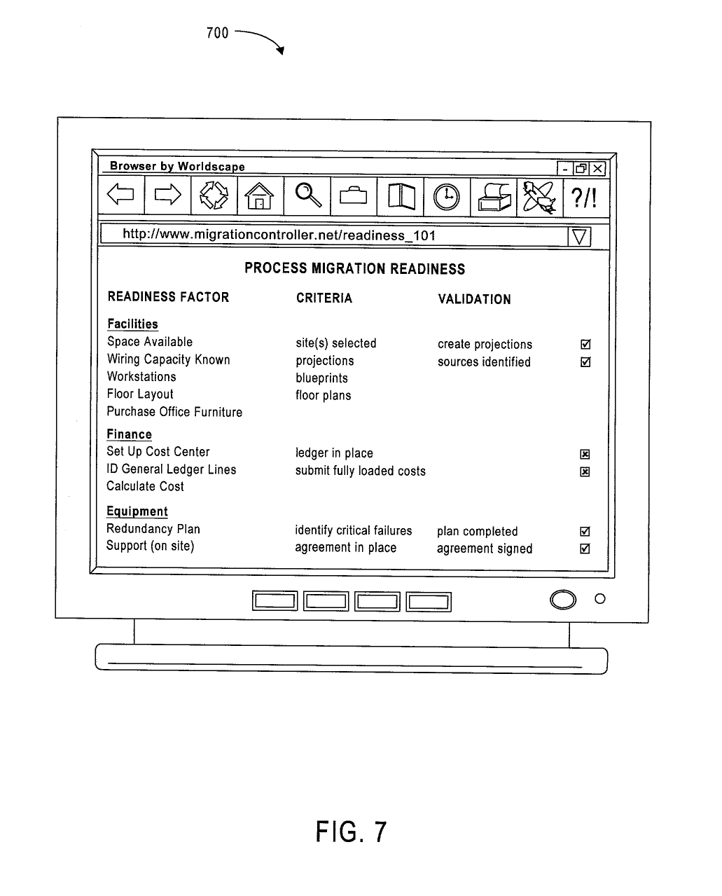

The readiness of the second location may also be determined via a site readiness checklist template. FIG. 7 is a process migration readiness display 700 according to some embodiments of the present invention. As can be seen, the display 700 includes a number of readiness factors (e.g., space availability, identification of general ledger lines and a redundancy plan). Each factor is associated with readiness criteria (e.g., a measurable action that needs to be performed) and validation information (e.g., that demonstrate the action was performed). The display 700 may also include an indication (e.g., a check box) of whether each factor is ready at the second location. Such a display 700 may help ensure that all aspects of the transition have been covered before the process migration is performed.

Referring again to FIG. 5, the current process is reviewed at 530 and adaptations are made to facilitate performance of the adapted process at the second location. That is, inputs, functions and/or outputs associated with the process may be adapted to enable and/or improve the process. For example, an input to the process may be adapted such that the input will arrive at the second location (i.e., as opposed to the first location). The adapted process is then detailed and documented.

According to some embodiments of the present invention, a Failure Modes and Effects Analysis (FMEA) and risk/contingency plan are automatically developed via a process migration toolkit template. The FMEA plan may organize potential product or process failures and the risks associated with those failures and describe actions that can be planned to reduce or eliminate those risks. Note that some of the information used to generate the FMEA plan may be based on the risk factors detailed during the solution identification step 320 in FIG. 3.

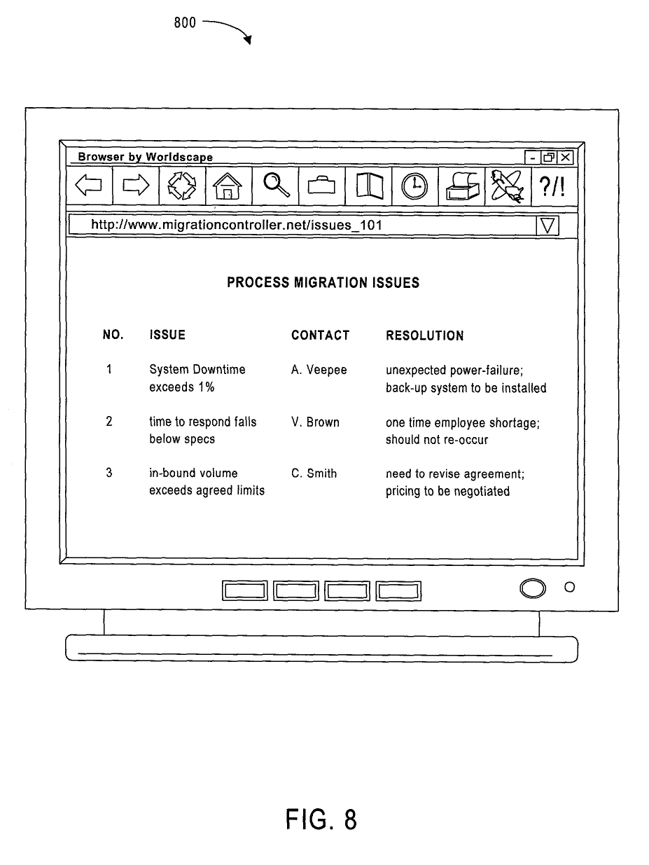

An issue escalation and resolution plan may also be automatically developed via a process migration toolkit template. FIG. 8 is a process migration issues display 900 according to some embodiments of the present invention. As can be seen, the display 900 may include, for example, a description of an issue (e.g., a problem associated with the process or the migration), an employee responsible for resolution of the issue, and a description of how the issue was (or will be) resolved. The display 900 may also include an employee who will be contacted if the issue escalates (e.g., if the problem worsens or is not resolved within a predetermined period of time).

Referring again to FIG. 5, the design is verified at 540. For example, the entire process migration plan may be reviewed by the customer at a tollgate. When the customer approves the design, a process migration toolkit template may be used to automatically generate a service level agreement with the customer. The service level agreement may, for example, be a contract that specifies the services that will be provided to the customer (e.g., a description and scope of services, service hours, reporting requirements, performance standards, minimum and maximum transaction volumes and per transaction costs). The service level agreement may also include various legal clauses associated with such contracts (e.g., confidentiality, indemnity and governing law clauses).

Referring again to FIG. 3, service is finally delivered via the second location at 340. That is, the migration is now complete and the process (i.e., the adapted process) is being performed at the second location instead of the first location. Of course, performance of the process at the second location may still be monitored to ensure quality.

Migration Controller

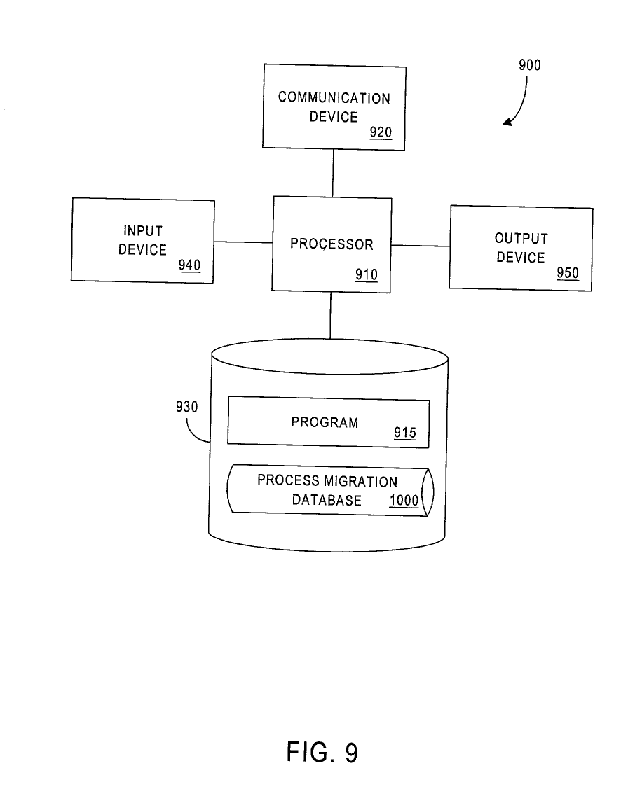

FIG. 9 illustrates a migration controller 900 that is descriptive of the device shown, for example, in FIG. 1 according to some embodiments of the present invention. The migration controller 900 comprises a processor 910, such as one or more INTEL® Pentium®) processors, coupled to a communication device 920 configured to communicate via a communication network (not shown in FIG. 9). The communication device 920 may be used to communicate, for example, with one or more user devices 10, customer devices 30, and/or other migration controllers 900.

According to some embodiments, the processor 910 also communicates with an input device 940. The input device 940 may comprise, for example, a keyboard or a mouse. Such an input device 940 may be used, for example, to enter information (e.g., information about a process migration). Similarly, the processor 910 may communicate with an output device 950, such as a display (e.g., a computer display screen), a speaker or a printer. The output device 950 may be used, for example, output information (e.g., a document associated with process migration).

The processor 910 is also in communication with a storage device 930. The storage device 930 may comprise any appropriate information storage device, including combinations of magnetic storage devices (e.g., magnetic tape and hard disk drives), optical storage devices and/or semiconductor memory devices such as Random Access Memory (RAM) devices and Read Only Memory (ROM) devices.

The storage device 930 stores a program 915 for controlling the processor 910. The processor 910 performs instructions of the program 915, and thereby operates in accordance with the present invention. For example, the processor 910 may receive, via a process migration template, information associated with a process performed at a first location. The processor 910 may then determine at least one adaptation to the process to facilitate performance of the adapted process at a second location (e.g., by receiving an indication of the adaptation from an operator). The processor 910 then helps to arrange for the adapted process to be performed at the second location.

As used herein, information may be “received” by or “transmitted” to, for example: (i) the migration controller 900 from a user device 10 or a customer device 30; or (ii) a software application or module within the migration controller 900 from another software application, module or any other source.

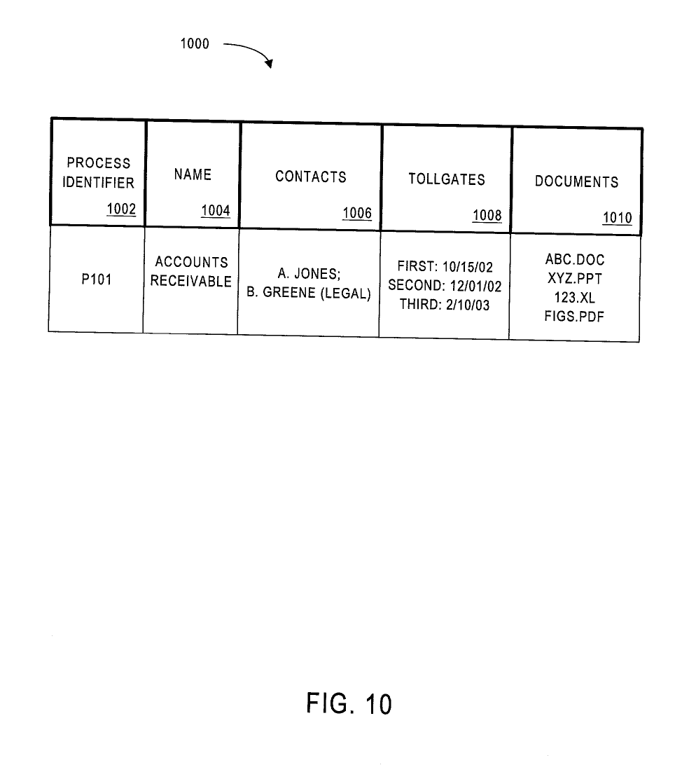

As shown in FIG. 9, the storage device 930 also stores a process migration database 1000. An example of a database that may be used in connection with the process migration system 100 will now be described in detail. The illustration and accompanying description of the database presented herein is exemplary, and any number of other database arrangements could be employed besides that suggested by FIG. 10.

Process Migration Database

Referring to FIG. 10, a table represents the process migration database 1000 that may be stored at the migration controller 900 according to an embodiment of the present invention. The table includes entries identifying processes that may be (or have been) moved from a first location to a second location via the process migration system 100. The table also defines fields 1002, 1004, 1006, 1008, 1010 for each of the entries. The fields specify: a process identifier 1002, a name 1004, contacts 1006, tollgates 1008, and documents 1010. The information in the process migration database 1000 may be created and updated, for example, based on information received from user devices 10 and/or customer devices 30.

The process identifier 1002 may be, for example, an alphanumeric code associated with a process that will be (or has been) moved from a first location to a second location via the process migration system 100. The name 1004 describes the process, and the contacts 1006 may indicate, for example, process migration team members or key process owners.

The tollgates 1008 define one or more tollgates associated with process migration (and may include information associated with the process migration tollgate display 600 of FIG. 6). The documents 1010 may indicate (or point to) documents that have been automatically generated (i.e., at least part of each document may have been automatically generated).

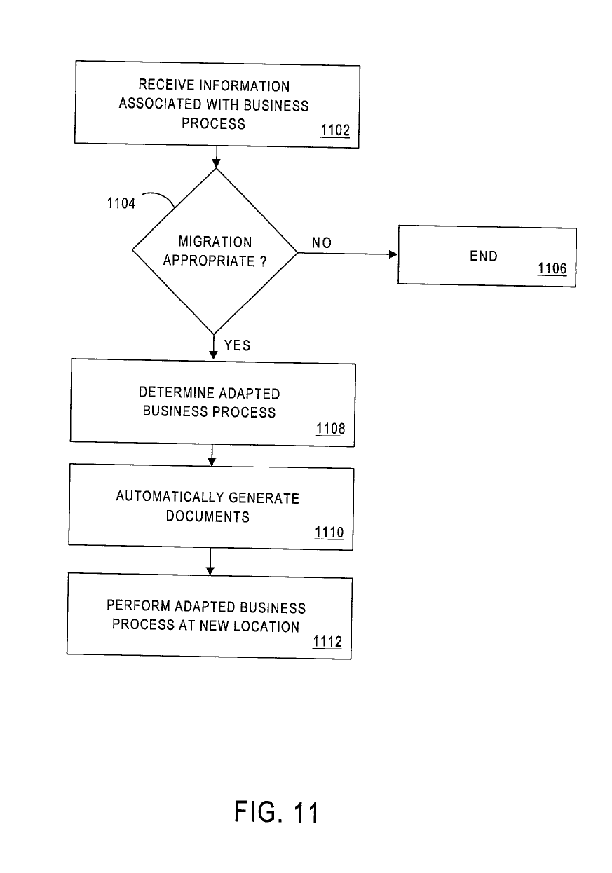

A method that may be used in connection with the process migration system 100 according to some embodiments of the present invention will now be described in detail with respect to FIG. 11.

Process Migration Method

FIG. 11 is a flow chart of a process migration method according to some embodiments of the present invention. At least a portion of the method may be performed, for example, by the migration controller 900. At 1102, information associated with a business process performed at a first geographic location is received via a process migration template. For example, the migration controller 900 may receive information associated with the business process from one or more user devices 10 and/or customer devices 30 via questionnaire templates and scorecard templates (e.g., as described with respect to FIG. 4). A process identifier 1002, name 1004, and appropriate contacts 1006 may then be stored in the process migration database 1000.

At 1004, it is then determined if the business process will be performed at a second geographic location. If it is determined that the process will not be migrated at 1104, the process ends at 1106.

If it is determined that the process will be migrated at 1104, appropriate adaptations to the business process are determined at 1108. For example, inputs, functions, and/or outputs associated with the business process may be adapted to enable and/or improve performance at the second geographic location.

Documents associated with the adapted business process and/or the process migration are then automatically generated at 1110. For example, the migration controller 900 may generate process migration tollgate and readiness documents and update the tollgates 1008 and documents 1010 in the process migration database 1000 as appropriate.

At 1112, the adapted business process is performed at the second geographic location. That is, the process has now been moved and is no longer performed at the first geographic location.

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In many embodiments described herein, a process is moved from a first physical location to a second physical location. According to other embodiments, a process may instead be migrated from a first group (employees or other parties associated with the customer) to a second group at the same physical location.

Similarly, a process may be moved from a number of different original locations to a single new location—or from a single original location to a number of different new locations.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating process migration, comprising:
receiving, via a process migration template, information associated with a process performed at a first location;
determining at least one adaptation to the process to facilitate performance of the adapted process at a second location; and
arranging for the adapted process to be performed at the second location.

2. The method of claim 1, wherein the process comprises at least one of: (i) a business process, (ii) an accounting process, (iii) a telephone call center process, and (iv) a human resources process.

3. The method of claim 1, wherein at least one of the first location and the second location comprises at least one of: (i) a company, (ii) a department, (iii) a region, and (iv) a country.

4. The method of claim 1, wherein said receiving is performed via a plurality of process migration templates.

5. The method of claim 1, wherein said receiving is performed via at least one of: (i) a personal computer, (ii) a portable computer, and (iii) a server.

6. The method of claim 1, wherein said receiving is performed via at least one of: (i) a communication network, (ii) an Internet protocol network, (iii) the Internet, (iv) a public network, (v) a proprietary network, and (vi) a wireless network.

7. The method of claim 1, wherein said receiving comprises:
receiving information from a plurality of customer employees.

8. The method of claim 1, wherein the information associated with the process comprises at least one of: (i) customer information, (ii) contact information, (iii) a process description, (iv) technology information, (v) human resources information, (vi) financial information, (vii) quality information, (viii) legal information, (ix) migration expectation information, (x) a feasibility score, (xi) a risk score, and (xii) schedule information.

9. The method of claim 1, wherein said determining comprises:
determining customer requirements associated with the process;
presenting a potential solution to the customer, including at least one of: (i) potential options, (ii) risk information, (iii) mitigation information, (iv) cost information, and (v) benefit information; and
receiving an indication of approval from the customer.

10. The method of claim 1, further comprising:
automatically generating at least one of: (i) a questionnaire, (ii) a project plan, (iii) a letter of commitment, and (iv) a requisition.

11. The method of claim 1, further comprising:
automatically generating at least one of: (i) tollgate information, (ii) a project plan, (iii) a communication plan, (iv) a baseline process, (v) volume information, (vi) a training record, (vii) a performance tracking plan, (viii) a site readiness checklist, (ix) a risk contingency plan, (x) an issue resolution plan, (xi) process monitoring information, and (xii) a service agreement.

12. The method of claim 1, wherein the adaptation to the process comprises at least one of: (i) an adapted process input, (ii) an adapted process output, and (iii) an adapted process function.

13. The method of claim 1, further comprising:
performing the adapted process at the second location.

14. The method of claim 1, further comprising:
determining whether or not the adapted process will be performed at the second location.

15. An apparatus, comprising:
a processor; and
a storage device in communication with said processor and storing instructions adapted to be executed by said processor to:
receive, via a process migration template, information associated with a process performed at a first location;
determine at least one adaptation to the process to facilitate performance of the adapted process at a second location; and
arrange for the adapted process to be performed at the second location.

16. The apparatus of claim 15, wherein said storage device further stores a process migration database.

17. The apparatus of claim 15, further comprising:
a communication device coupled to said processor and adapted to communicate with at least one of: (i) a user device, (ii) a customer device, and (iii) a mitigation controller.

18. A medium storing instructions adapted to be executed by a processor to perform a method of facilitating process migration, said method comprising:
receiving, via a process migration template, information associated with a process performed at a first location;
determining at least one adaptation to the process to facilitate performance of the adapted process at a second location; and
arranging for the adapted process to be performed at the second location.

19. A computer-implemented method of facilitating process migration, comprising:
receiving via a process migration template information associated with a business process performed at a first geographic location;
determining that an adapted business process will be performed at a second geographic location;
automatically generating documents associated with the adapted business process; and
performing the adapted business process at the second geographic location.
